(19) United States
(12) Patent Application Publication
(10) Pub. No.: US 2019/0248486 A1
(43) Pub. Date: Aug. 15, 2019

(54) FLIGHT DEVICE

(71) Applicant: Coretronic Intelligent Robotics Corporation, Hsinchu County (TW)

(72) Inventors: Ying-Chieh Chen, Hsinchu County (TW); Shih-Hang Lin, Hsinchu County (TW); Chi-Tong Hsieh, Hsinchu County (TW)

(73) Assignee: Coretronic Intelligent Robotics Corporation, Hsinchu County (TW)

(21) Appl. No.: 16/261,590

(22) Filed: Jan. 30, 2019

(30) Foreign Application Priority Data
Feb. 13, 2018 (CN) 201820257403.8

(51) Int. Cl. B64C 39/02; B64C 27/82

(52) U.S. Cl. CPC B64C 39/024; B64C 2201/108; B64C 2201/027; B64C 27/82

(57) ABSTRACT

A flight device including a device main body and a plurality of lift force providing modules is provided. The lift force providing modules are connected to the device main body. Each of the lift force providing modules includes two propellers, and each of the propellers rotates to lift the device main body. Two propellers of each of the lift force providing modules may rotate around the same rotation axis. The flight device has an enhanced lift force and good efficiency in lifting, and the flight device has a reduced device volume and improved flight reliability.

### CROSS-REFERENCE TO RELATED APPLICATION

This application claims the priority benefit of China application serial no. 201820257403.8, filed on Feb. 13, 2018. The entirety of the above-mentioned patent application is hereby incorporated by reference herein and made a part of this specification.

### BACKGROUND OF THE INVENTION

### Field of the Invention

The invention relates to a flight device, and particularly relates to a multirotor flight device.

### Description of Related Art

With the rapid development of technology, in recent years, major electronics companies have been actively engaged in the market of unmanned aircraft system (UAS), unmanned aerial vehicle (UAV), etc., which are originally applied in military fields and whose cost for development have been reduced. Among other applications of UAS/UAV, cargo/food delivery and sports photography have been fields of interest for major electronics companies to research. The UAV market is expected to bring a lot of job opportunities, and have an enormous economic potential.

However, accidents caused by failure of single-axis UAV motor have always been an insurmountable problem.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention ware acknowledged by a person of ordinary skill in the art.

### SUMMARY OF THE INVENTION

The invention is directed to a flight device, which has an enhanced lift force and good efficiency in lifting, and has a reduced device volume and improved flight reliability.

Other objects and advantages of the invention can be understood further by ways of the technical features broadly embodied and described as follows.

In order to achieve one or a portion of or all of the objects or other objects, the invention provides a flight device including a device main body and a plurality of lift force providing modules. The lift force providing modules are connected to the device main body. Each of the lift force providing modules includes two propellers, and each of the propellers rotates to lift the device main body. Two propellers of each of the lift force providing modules may rotate around the same rotation axis.

Based on the above description, the embodiments of the invention have at least one of the following advantages or effects. Each of the lift force providing modules of the flight device of the invention includes two propellers, so that each of the lift force providing modules of the invention may provide a larger lift force and has better lifting efficiency than the conventional flight devices which have a single propeller for each axis. Therefore, the lift force may be increased without additional blades for a propeller or additional lift force providing modules, so that a disturbance of the available flow field caused by excessive blades is avoided, and an increase in overall device volume caused by excessive lift force providing modules is avoided. Moreover, when one of the propellers of a single lift force providing module fails, which may cause a loss in lifting force, a compensation in lifting force and a balance in the overall torque of the lift force providing modules may be provided by ways of adjusting the rotation speed of another propeller of such lift force providing module or by ways of adjusting the rotation speed of the propellers of the other lift force providing modules. Therefore, compared to the conventional technique that only a single propeller is configured for each axis, the lift force providing modules of the embodiments of the invention may have better performance in case of a propeller failure, so that flight reliability is greatly improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of a flight device according to an embodiment of the invention.

FIG. 2 is a top view of the flight device of FIG. 1.

FIG. 3 is a partial enlarged figure of the flight device of FIG. 1.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

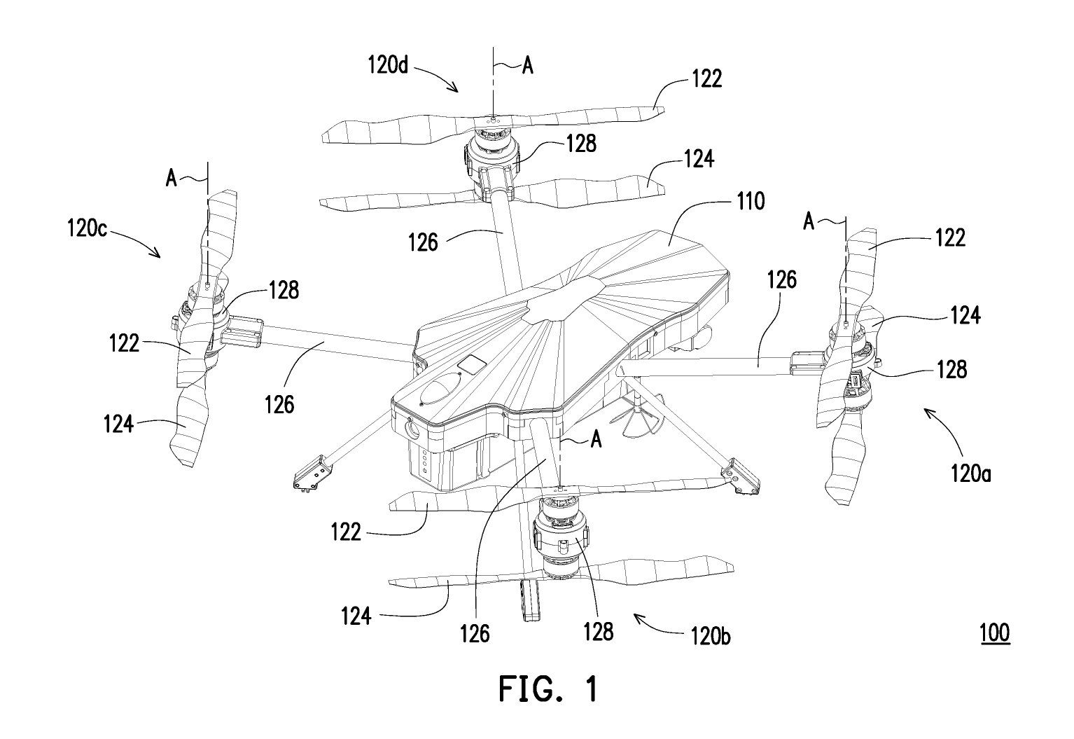

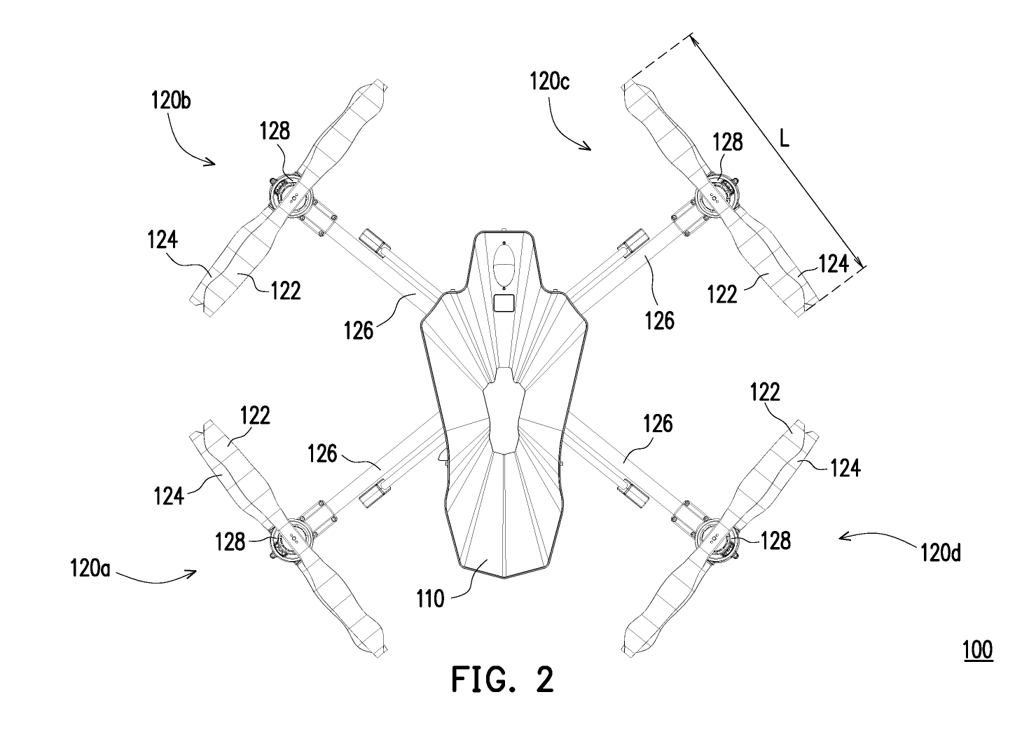

FIG. 1 is a three-dimensional view of a flight device according to an embodiment of the invention. FIG. 2 is a top view of the flight device of FIG. 1. Referring to FIG. 1 and FIG. 2, the flight device 100 of the present embodiment is, for example, an unmanned aerial vehicle (UAV) and includes a device main body 110 and a plurality of lift force providing modules 120a, 120b, 120c, 120d. The lift force providing modules 120a-120d are connected to the device main body 110, and each of the lift force providing modules 120a/120b/120c/120d includes two propellers 122, 124, and the two propellers 122, 124 are respectively an upper propeller and a lower propeller as those shown in FIG. 1. Each of the propellers 122, 124 rotates to lift the device main body 110, and the two propellers 122, 124 of each of the lift force providing modules 120a/120b/120c/120d rotate around the same rotation axis.

With the lift force providing modules 120a-120d, the flight device 100 of the present embodiment is a multirotor flight device. To be specific, the lift force providing modules 120a-120d surround the device main body 110, and a rotation axis A of the two propellers 122, 124 of any one of the lift force providing modules 120a-120d is different from another rotation axis A of the two propellers 122, 124 of any other one of the lift force providing modules 120a-120d. The rotation axis A of the two propellers 122, 124 of any one of the lift force providing modules 120a-120d is parallel to the another rotation axis A of the two propellers 122, 124 of any other one of the lift force providing modules 120a-120d. For example, the rotation axis A of the two propellers 122, 124 of any lift force providing module (for example, 120a) is different t from the rotation axes A of the two propellers 122, 124 of the other lift force providing modules (for example, 120b-120d), and the rotation axis A of the two propellers 122, 124 of any lift force providing module (for example, 120a) is parallel to the rotation axes A of the two propellers 122, 124 of the other lift force providing modules (for example, 120b-120d).

Moreover, rotation directions of the two propellers 122, 124 of each of the lift force providing modules 120a/120b/120c/120d are different. The rotation direction of the propeller 122 (i.e. the upper propeller) of one of the lift force providing modules 120a-120d (for example, 120a) is opposite to the rotation direction of the propeller 122 (i.e. the upper propeller) of another one of the lift force providing modules 120a-120d (for example, 120b/120d) which is adjacent to the one of the lift force providing modules 120a-120d (for example, 120a). The rotation direction of the propeller 124 (i.e. the lower propeller) of one of the lift force providing modules 120a-120d (for example, 120a) is opposite to the rotation direction of the propeller 124 (i.e. the lower propeller) of another one of the lift force providing modules 120a-120d (for example, 120b/120d) which is adjacent to the one of the lift force providing modules 120a-120d (for example, 120a). In this way, torque of the lift force providing modules 120a-120d is balanced.

In the present embodiment, the flight device 100, for example, may be a four-axis device with the configuration of four lift force providing modules 120. However, the invention is not limited thereto. In other embodiments, the flight device 100 may be a two-axis device, a three-axis device, a five-axis device, a sixth-axis device, a seven-axis device, an eight-axis device or devices with any other number of axes.

Since each of the lift force providing modules 120a/120b/120c/120d of the flight device 100 of the present embodiment includes two propellers 122, 124, each of the lift force providing modules 120a/120b/120c/120d of the invention may provide a larger lift force and has better efficiency in lifting compared to the conventional technique that only a single propeller is configured for each axis. Therefore, in the present embodiment, the lift force may be increased without additional blades for the propellers 122, 124 or additional lift force providing modules 120a-120d, so that a disturbance of the available flow field caused by excessive blades is avoided, and an increase in overall device volume caused by excessive lift force providing modules 120a-120d is avoided. Compared to the conventional technique that only a single propeller is configured for each axis, by designing two propellers for each of the lift force providing modules 120a/120b/120c/120d, a lift output efficiency is improved by 10-14% under the same lift force, and a lift force is increase by 53% in maximum under the same rotation speed. In an embodiment, an increase 50% in load capacity is achieved under the same space axes distance.

On the other hand, in the present embodiment, when one of the two propellers 122 (or 124) in one of the lift force providing modules 120a-120d fails, a rotation speed of another propeller 124 (or 122) of such lift force providing module may be adjusted or the rotation speeds of the propellers 122, 124 of the other lift force providing modules may be adjusted to compensate the loss in lift force caused by the failed propeller and an overall torque of the lift force providing modules 120a-120d is such balanced. Therefore, compared to the conventional technique that only a single propeller is configured for each axis, the lift force providing modules 120a-120d of the present embodiment may have better performance in case of a propeller failure, so that flight reliability is greatly improved.

For example, in an embodiment, when the propeller 122 of the lift force providing module 120a fails, a rotation speed of the propeller 124 of the lift force providing module 120a and/or a rotation speed of the propeller 122 of the lift force providing module 120c may be increased, and the propeller 124 of the lift force providing module 120c may be stopped or a speed thereof is decreased to compensate the loss in lift force and the torque is such maintained in balance or substantially in balance. The rotation speeds of the propellers 122, 124 of the lift force providing module 120b and the propellers 122, 124 of the lift force providing module 120d may be further increased to help the propeller 124 of the lift force providing module 120a and the propeller 122 of the lift force providing module 120c. As such, the flight device may be returned back for maintenance or may be landed in place.

Moreover, in an embodiment, when the propeller 122 of the lift force providing module 120a fails, and the propeller 122 of the lift force providing module 120d fails, a rotation speed of the propeller 124 of the lift force providing module 120a, a rotation speed of the propeller 124 of the lift force providing module 120b, a rotation speed of the propeller 124 of the lift force providing module 120c, and a rotation speed of the propeller 124 of the lift force providing module 120d may be all increased, and the propeller 122 of the lift force providing module 120b and the propeller 122 of the lift force providing module 120c may be stopped to compensate the loss in lift force and the torque is such maintained in balance. As such, the flight device may be landed in place.

Moreover, in an embodiment, when the propellers 122, 124 of the lift force providing module 120a fails, rotation speeds of the propellers 122, 124 of the lift force providing module 120b and rotation speeds of the propellers 122, 124 of the lift force providing module 120d may be increased, and the propellers 122, 124 of the lift force providing module 120c may be stopped to compensate the loss in lift force and such the torque is such maintained in balance. As such, the flight device may be landed in place.

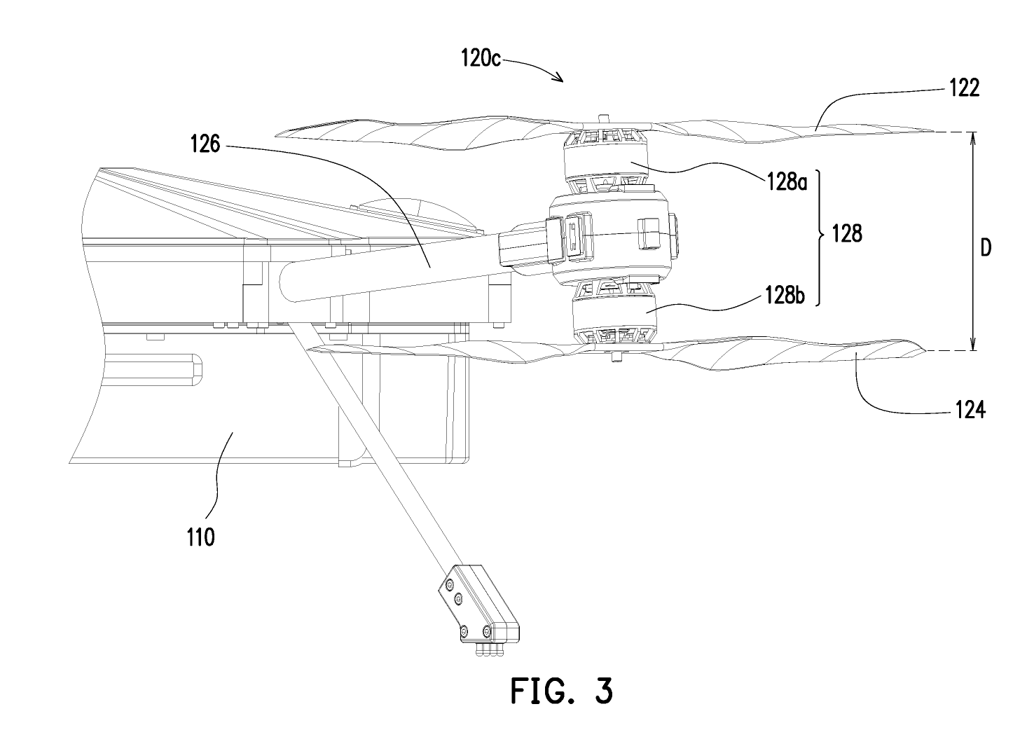

FIG. 3 is a partial enlarged figure of the flight device of FIG. 1. A distance D (indicated in FIG. 3) between the two propellers 122, 124 of each of the lift force providing modules 120a/120b/120c/12d (for example, the lift force providing module 120c of FIG. 3) is, for example, smaller than 0.3 times a maximum length L (indicated in FIG. 2) of each of the propellers 122/124, so that the space between the two propellers 122, 124 is not excessively large, and better lifting efficiency is achieved. In this way, the affect of a turbulence is mitigated.

As shown in FIG. 1 to FIG. 3, each of the lift force providing modules 120a/120b/120c/12d of the present embodiment includes a rod member 126 and a driving assembly 128. One end of the rod member 126 is connected to the device main body 110, and the other end of the rod member 126 is configured with the two propellers 122, 124. The driving assembly 128 is disposed between the two propellers 122, 124 to rotate the two propellers 122, 124. In detail, as shown in FIG. 3, each of the driving assemblies 128 includes two actuators 128a, 128b, and the two actuators 128a, 128b are respectively connected to the two propellers 122, 124 and are respectively used to rotate the two propellers 122, 124. By configuring two independent actuators 128a, 128b for each of the driving assemblies 128, the two propellers 122, 124 may be rotated in opposite rotation directions. When one actuator 128a (or 128b) fails, the other actuator 128b (or 128a) may continually operate.

In summary, the embodiments of the invention have at least one of the following advantages or effects. Each of the lift force providing modules of the flight device of the invention includes two propellers, so that compared to the conventional technique that only a single propeller is configured for each axis, each of the lift force providing modules of the invention may provide a larger lift force and has better lifting efficiency. Therefore, it is unnecessary to increase the number of blades of the propeller or increase the number of the lift force providing modules in order to increase the lift force, so as to avoid disturbance of a flow field of available airflows caused by excessive blades, and avoid increasing an overall device volume due to excessive lift force providing modules. Moreover, when one of the propellers of a single lift force providing module fails, a rotation speed of another propeller of such lift force providing module may be adjusted or rotation speeds of the propellers of the other lift force providing modules may be adjusted to compensate the loss of lift force caused by the failed propeller and such an overall torque of the lift force providing modules is balanced. Therefore, compared to the conventional technique that only a single propeller is configured for each axis, the lift force providing modules of the embodiments of the invention may have better performance in case of a propeller failure, so that flight reliability is greatly improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A flight device, comprising:
a device main body; and
a plurality of lift force providing modules, connected to the device main body, wherein each of the lift force providing modules comprises two propellers, and each of the two propellers rotates to lift the device main body, and the two propellers of each of the lift force providing modules rotate around the same rotation axis.

2. The flight device as claimed in claim 1, wherein a rotation axis of the two propellers of any one of the lift force providing modules is different from another rotation axis of the two propellers of any other one of the lift force providing modules.

3. The flight device as claimed in claim 1, wherein a rotation axis of the two propellers of any one of the lift force providing modules is parallel to another rotation axis of the two propellers of any other one of the lift force providing modules.

4. The flight device as claimed in claim 1, wherein the two propellers of each of the lift force providing modules rotate in opposite rotation directions.

5. The flight device as claimed in claim 1, wherein the two propellers of each of the lift force providing modules comprise an upper propeller and a lower propeller, and wherein a rotation direction of the upper propeller of one of the lift force providing modules is opposite to another rotation direction of the upper propeller of another one of the lift force providing modules, the another one of the lift force providing modules is adjacent to the one of the lift force providing modules, and a rotation direction of the lower propeller of one of the lift force providing modules is opposite to another rotation direction of the lower propeller of another one of the lift force providing modules, the another one of the lift force providing modules is adjacent to the one of the lift force providing modules.

6. The flight device as claimed in claim 1, wherein a distance between the two propellers of each of the lift force providing modules is smaller than 0.3 times a maximum length of each of the two propellers.

7. The flight device as claimed in claim 1, wherein the lift force providing modules surround the device main body.

8. The flight device as claimed in claim 1, wherein each of the lift force providing modules further comprises a rod member, one end of the rod member is connected to the device main body, and the other end of the rod member is configured with the two propellers of each of the lift force providing modules.

9. The flight device as claimed in claim 1, wherein each of the lift force providing modules further comprises a driving assembly, and the driving assembly is disposed between the two propellers of each of the lift force providing modules.

10. The flight device as claimed in claim 9, wherein the driving assembly comprises two actuators, and in the driving assembly, the two actuators are respectively connected to the two propellers and respectively used to rotate the two propellers.
